(19) United States
(12) Patent Application Publication
(10) Pub. No.: US 2013/0019256 A1
(43) Pub. Date: Jan. 17, 2013

(54) INFORMATION RECORDING MEDIUM AND METHOD FOR PRODUCING SAME, AND INFORMATION RECORDING MATERIAL

(71) Applicants: Kouki Hatsuda, Tochigi (JP); KyungSung Yun, Tochigi (JP)

(72) Inventors: Kouki Hatsuda, Tochigi (JP); KyungSung Yun, Tochigi (JP)

(73) Assignee: Sony Chemical & Information Device Corporation, Tokyo (JP)

(21) Appl. No.: 13/638,516

(22) PCT Filed: Jun. 9, 2011
(86) PCT No.: PCT/JP2011/063284

§ 371 Date: Sep. 28, 2012

(30) Foreign Application Priority Data
Jun. 10, 2010 (JP) 2010-132840

(51) Int. Cl. G11B 7/24; B32B 37/12; C08G 59/24; G11B 7/0045

(52) U.S. Cl. 720/718; 156/330; 528/418; G9B/7.139; G9B/7.016

(57) ABSTRACT

An information recording medium excellent in long storage and capable of high-density recording, method of manufacturing the information recording medium, and information recording material are provided. Pulse laser light is focused onto a recording layer in which a thermosetting epoxy resin having a skeleton with high planarity and a curing agent are polymerized to form a recording mark. With a cured material of a recording layer having a density equal to or larger than 1.210 g/cm³ and a glass transition temperature of 110° C. to 140° C., high-speed recording is possible.

### FIELD OF THE INVENTION

This invention relates to an information recording medium where information is recorded with high-intensity pulse laser light and method of manufacturing the information recording medium, and information recording material. The present application claims priority rights to JP Patent Application 2010-132840 filed in Japan on Jun. 10, 2010, which is hereby incorporated by reference.

### BACKGROUND OF THE INVENTION

As a next-generation optical disc recording method, technologies have been disclosed in which recording light is focused to form recording marks made of cavities near a focus of the recording light (for example, refer to PTL 1 to PTL 3). In these recording methods, a CW (Continuous Wave) laser is used as a light source. Therefore, an information recording material contains a highly photosensitive material in photothermal mode, such as a photosensitizer or a photo-acid-generating material in photothermal mode, such as a photosensitizer or a photo-acid-generating agent.

### PRIOR-ART DOCUMENTS

### Patent Documents

PTL 1: Japanese Patent Application Laid-Open No. 2009-59404

PTL 2: Japanese Patent Application Laid-Open No. 2010-15631

PTL 3: Japanese Patent Application Laid-Open No. 2010-15632

### SUMMARY OF THE INVENTION

In the recording methods described above, since the information recording medium contains a large amount of the highly photosensitive material in photothermal mode, photothermal degradation is severe. In long storage for fifty years or so, the recording marks are potentially lost. Also, since formation of recording marks is caused by a chemical reaction of the highly photosensitive material in photothermal mode, it is difficult to improve the recording speed.

The present invention is suggested in view of these realities, and provides an information recording medium excellent in long storage and capable of high-density recording, method of manufacturing the information recording medium, and information recording material.

As a result of diligent studies, the inventors have found that, by adopting laser ablation with high peak power pulse laser to make the void marks and by adopting recording material which is thermo-curable epoxy resin with high crosslinking density and high packing density (high planarity), the medium can be excellent in long archive life and shelf life and high density recording.

That is, an information recording medium according to the present invention has a recording layer whose material is made of epoxy resin polymerized with a monomer having two or more benzene rings by curing agent and the recording layer having a density equal to or larger than 1.210 g/cm³, wherein a recording mark is to be formed or has been formed in the recording layer.

Also, an information recording medium manufacturing method according to the present invention, has a recording layer whose material is made of epoxy resin polymerized with a monomer having two or more benzene rings by curing agent between transparent substrate to form a recording layer having a density equal to or larger than 1.210 g/cm³.

Furthermore, an information recording material according to the present invention, has a recording layer whose material is made of epoxy resin polymerized with a monomer having two or more benzene rings by curing agent, and the information recording material has a density equal to or larger than 1.210 g/cm³.

### Effects of Invention

According to the present invention, since a large amount of the highly photosensitive material such as a photosensitizer or a photo-acid-generating agent in photothermal mode is not contained in the recording layer, a high degree of reliability can be obtained for long storage. Also, since the recording layer is formed with high density from a thermosetting epoxy resin having a skeleton with high planarity, recording marks can be formed at high speed by concentrating recording light.

### BRIEF DESCRIPTION OF DRAWINGS

FIG. 1 is a schematic view of a recording method in an embodiment of the present invention.

FIG. 2 is a graph showing a relation between density and write time when Tg is fixed.

FIG. 3 is a graph showing a relation between density and write time when density is fixed.

FIG. 4 is a graph showing a relation between glass transition temperature and density.

### DETAILED DESCRIPTION OF THE INVENTION

Embodiments of the present invention are described in detail below in the following order with reference to the drawings.

1. Summary of Recording Method

2. Information Recording Medium

3. Examples

### 1. SUMMARY OF RECORDING METHOD

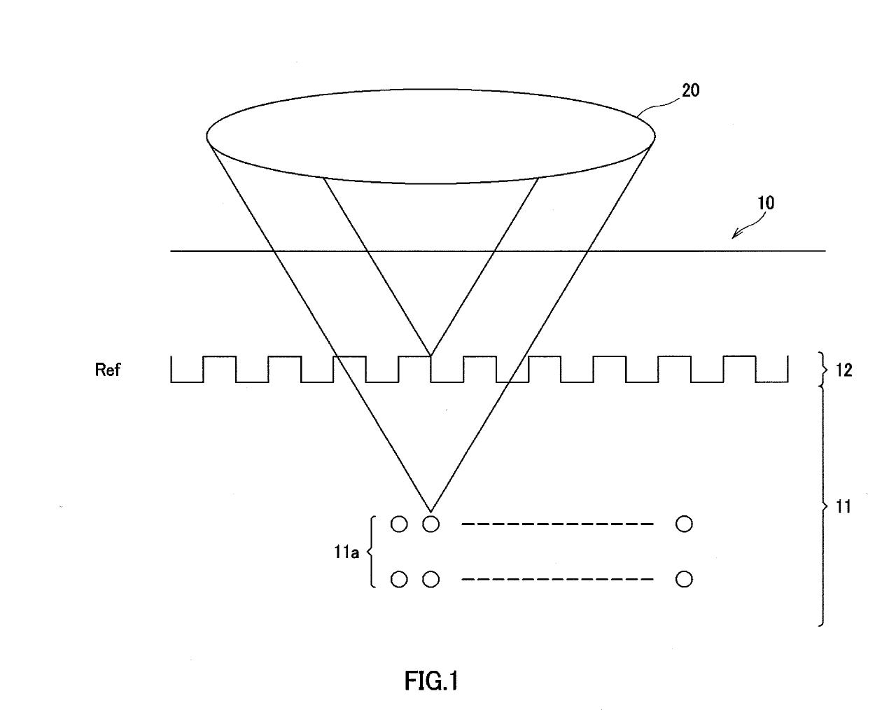

FIG. 1 is a schematic view of a recording method in an embodiment of the present invention. In the recording method in the present embodiment, by laser abrasion with pulse laser light, recording marks 11a formed of cavities are formed on a recording layer 11 of an information recording medium 10.

As a light source of pulse laser light, the one capable of oscillating high-intensity pulses with a pulse width equal to or smaller than 1 nsec can be used. Examples of this light source include a semiconductor laser made of GaInN or others disclosed in Applied Physics Letters 93, 131113 (2008) and others and a solid laser such as a titanium:sapphire laser (hereinafter abbreviated as a Ti:S laser).

The pulse laser light is focused by an objective lens 20 onto a predetermined position on the recording layer 11. With material vaporization by laser abrasion, the recording marks 11a made of cavities are formed on the recording layer 11. Note that the recording marks 11a are formed at a three-dimensionally accurate position by using, for example, a guide pattern 12 formed on a glass substrate.

As such, by forming recording marks by using laser abrasion, a photosensitizer, a photo- acid-generating agent, or the like does not have to be contained in the recording layer 11. Therefore, the possibility of loss of recording marks is decreased, thereby obtaining a high degree of reliability for long storage.

### 2. INFORMATION RECORDING MEDIUM

Next, the structure of the information recording medium in an embodiment of the present invention is described. The information recording medium represented as a specific example functions as a so-called medium for recording information by forming a recording layer between substrates. The shape of the information recording medium is not particularly restrictive, and the information recording medium may be formed in a rectangular plate shape or, like an optical disc such as BD (Blu-ray Disc, registered trademark) or DVD (Digital Versatile Disc), in a disc shape having a diameter of 120 mm and having a hole for chucking at the center.

The recording layer is formed of a cured material in which a thermosetting epoxy resin having a skeleton with high planarity and a curing agent are polymerized. Examples of the skeleton with high planarity include a naphthalene skeleton (A), a fluorene skeleton (B), an anthracene skeleton (C), a bisphenol A skeleton (D), and a biphenyl skeleton (E), which have two or more benzene rings in a molecule of any of monomers represented in General Formulas (A) to (E) below.

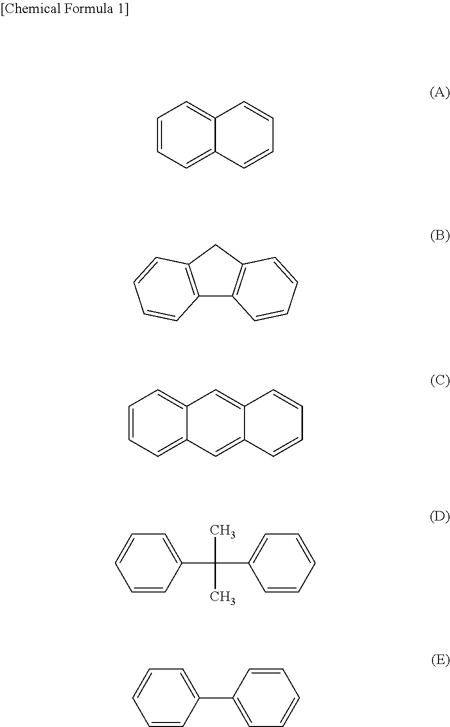

Also, the number of functional groups of the epoxy resin (pre-monomer) (an average number of epoxy groups per molecule) is desirably two or more in order to achieve high-density three-dimensional cross-linking. Specific examples of the epoxy resin include naphthalene-type bifunctional epoxy resins (“HP4032” and “HP4032D” manufactured by DIC Corporation), a naphthalene-type quatro-functional epoxy resin (“HP4700” manufactured by DIC Corporation), a naphthol-type epoxy resin (“ESN-475V” manufactured by Tohto Kasei Co., Ltd.), fluorene-type epoxy resins (“ONCOAT 1020”, “ONCOAT 1012”, and “ONCOAT 1040” manufactured by Nagase Chemtex Corporation and “OGSOL EG” manufactured by Osaka Gas Chemicals Co., Ltd.), liquid bisphenol-A-type epoxy resins (“830 CRP” manufactured by DIC Corporation and “EPICOAT 828EL” (“jER 828EL”) manufactured by Japan Epoxy Resins Co., Ltd.), biphenyl-type epoxy resins (“NC3000H” and “NC3000L” manufactured by Nippon Kayaku Co., Ltd. and “YX4000” manufactured by Japan Epoxy Resins Co., Ltd.), and an anthracene-analogous-type epoxy resin (“YX8800” manufactured by Japan Epoxy Resins Co., Ltd). Any one of these epoxy resins may be used alone or two or more of these epoxy resins may be used in combination.

The curing agent is not particularly restrictive as long as it sufficiently achieves the effects of the present invention, and any of an amine compound, sulfonate, iodonium salt, imidazoles, and acid anhydrides (phthalic acid, phthalic anhydride, and hexahydrophthalic anhydride) can be used. One or two or more curing agents can be used singly or in combination. Also, the amount of curing agent in the epoxy resin composite is normally 0.1 phr (Per Hundred Resin) to 10 phr.

This cured material with the epoxy resin and the curing agent polymerized is formed of an epoxy resin having two or more benzene rings in a molecule of a monomer. Therefore, steric hindrance is small, and three-dimensional crosslinks are established with high density.

In abrasion, High laser flux provides atoms and molecules at focus of laser with a large kinetic energy. It is favorable for the recording speed that more atoms and molecules exist at focus of laser because a number of atoms and molecules which absorb the kinetic energy increase. It is also favorable for recording speed that recording material is having proper “Hardness”. “Hardness” is determined by glass transition temperature, molecular weight between cross-linking points, and Young's modulus.

The amount of kinetic energy is determined based on physical properties of the laser light source and the recording material and, by way of example, is proportional to the number of atoms per unit volume of the recording material, that is, density. In the present embodiment, with the density of the epoxy resin cured material being equal to or larger than 1.210 g/cm³, the recording speed can be improved.

Also, regarding the “hardness” of the recording material, the glass transition temperature is preferably 110° C. to 140° C. With the glass transition temperature being equal to or higher than 110° C., it is possible to prevent cavities once formed from being filled due to an abrupt temperature change by pulse laser light. Furthermore, with the glass transition temperature being equal to or lower than 140° C., the amount of kinetic energy for forming cavities can be saved.

More preferably, the density of the recording layer is equal to or larger than 1.240 g/cm³, and the glass transition temperature of 120° C. to 130° C. With this not only the recording speed but also signal characteristics can be improved.

In the method of manufacturing the information recording medium in the present embodiment, a thermosetting epoxy resin having the flat skeleton described above and a curing agent are polymerized between transparent substrates to form a recoding layer having a density equal to or larger than 1.210 g/cm³. Specifically, a transparent substrate such as glass or polycarbonate is coated with the epoxy resin and the curing agent of a predetermined thickness, and another transparent substrate is placed thereon for interposing. Then, the epoxy resin and the curing agent are subjected heat polymerization and crosslink curing by an oven or the like. With this, an information recording medium having a recording layer can be manufactured.

### 3. EXAMPLES

Examples of the present invention are described below. Here, recording marks were written with a pulse laser onto fabricated information recording media of Sample 1 to Sample 15, with irradiation time changed, and write time was evaluated. Note that the present invention is not restricted to these examples.

[Sample 1]

To a bifunctional naphthalene-type epoxy resin (product name: HP-4032D, manufactured by DIC Corporation) represented by Compound 1 below, 0.4 phr of tris(dimethylaminomethyl)phenol (product name: DMP-30, manufactured by Kanto Chemical Co., Inc.) represented by Compound 2 below as a curing agent was added for mixing and deaerating. This mixture liquid was applied onto a cover glass substrate having a thickness of 0.15 mm, the mixture liquid being adjusted so as to have a thickness of 0.25 mm. Then, a glass substrate having a thickness of 0.75 mm was placed thereon for interposing. This entire test sample was left in an oven at 80° C. for twenty-four hours for heat polymerization and crosslink curing of the mixture liquid, thereby fabricating the information recording medium of Sample 1.

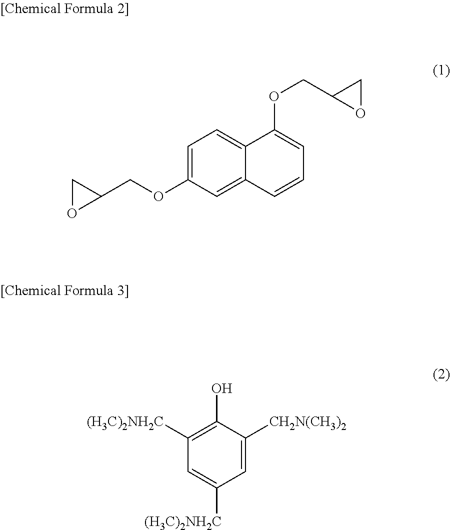

[Sample 2]

The information recording medium of Sample 2 was fabricated under conditions similar to those of Sample 1 except that the amount of addition of tris(dimethylaminomethyl)phenol (product name: DMP-30, manufactured by Kanto Chemical Co., Inc.) was set at 0.5 phr and the medium was left in the oven at 80° C. for twelve hours.

[Sample 3]

The information recording medium of Sample 3 was fabricated under conditions similar to those of Sample 1 except that the amount of addition of tris(dimethylaminomethyl)phenol (product name: DMP-30, manufactured by Kanto Chemical Co., Inc.) was set at 1.0 phr and the medium was left in the oven at 80° C. for twelve hours.

[Sample 4]

The information recording medium of Sample 4 was fabricated under conditions similar to those of Sample 1 except that the amount of addition of tris(dimethylaminomethyl)phenol (product name: DMP-30, manufactured by Kanto Chemical Co., Inc.) was set at 2.0 phr and the medium was left in the oven at 80° C. for twelve hours.

[Sample 5]

The information recording medium of Sample 5 was fabricated under conditions similar to those of Sample 1 except that the amount of addition of tris(dimethylaminomethyl)phenol (product name: DMP-30, manufactured by Kanto Chemical Co., Inc.) was set at 4.0 phr and the medium was left in the oven at 80° C. for twelve hours.

[Sample 6]

The information recording medium of Sample 6 was fabricated under conditions similar to those of Sample 1 except that the amount of addition of tris(dimethylaminomethyl)phenol (product name: DMP-30, manufactured by Kanto Chemical Co., Inc.) was set at 6.0 phr and the medium was left in the oven at 80° C. for twelve hours.

[Sample 7]

The information recording medium of Sample 7 was fabricated under conditions similar to those of Sample 1 except that, in place of tris(dimethylaminomethyl)phenol (product name: DMP-30, manufactured by Kanto Chemical Co., Inc.), 1.0 phr of a special amine-based curing agent (product name: U-Cat 18X, manufactured by San-Apro Ltd.) was added, and the sample was left in the oven at 80° C. for twenty-four hours.

[Sample 8]

The information recording medium of Sample 8 was fabricated under conditions similar to those of Sample 7 except that 1.5 phr of the special amine-based curing agent (product name: U-Cat 18X, manufactured by San-Apro Ltd.) was added.

[Sample 9]

The information recording medium of Sample 9 was fabricated under conditions similar to those of Sample 7 except that 2.0 phr of the special amine-based curing agent (product name: U-Cat 18X, manufactured by San-Apro Ltd.) was added.

[Sample 10]

The information recording medium of Sample 10 was fabricated under conditions similar to those of Sample 7 except that 3.0 phr of the special amine-based curing agent (product name: U-Cat 18X, manufactured by San-Apro Ltd.) was added.

[Sample 11]

The information recording medium of Sample 11 was fabricated under conditions similar to those of Sample 7 except that 4.0 phr of the special amine-based curing agent (product name: U-Cat 18X, manufactured by San-Apro Ltd.) was added.

[Sample 12]

The information recording medium of Sample 12 was fabricated under conditions similar to those of Sample 7 except that 6.0 phr of the special amine-based curing agent (product name: U-Cat 18X, manufactured by San-Apro Ltd.) was added.

[Sample 13]

A fluorene-type epoxy resin (product name: ONCOAT 1020, manufactured by Nagase ChemteX Corporation) and an acid anhydride as a curing agent (product name: YH 1120, manufactured by Japan Epoxy Resins Co., Ltd.) were mixed and dissolved at (64:36) so as to be equivalent, thereby preparing an A liquid. Also, A fluorene-type epoxy resin (product name: ONCOAT EX 1040, manufactured by Nagase ChemteX Corporation) and an acid anhydride (product name: YH 1120, manufactured by Japan Epoxy Resins Co., Ltd.) as a curing agent were mixed and dissolved at (54:46) so as to be equivalent, thereby preparing a B liquid. Then, the A liquid and the B liquid were mixed together at a ratio of 7:3, and 2.0 phr of a special amine-based curing agent (product name: U-Cat 18X, manufactured by San-Apro Ltd.) was then added as a curing accelerator, thereby obtaining a mixture liquid. This mixture liquid had the following composition: 45 parts by mass of EX 1020, 16 parts by mass of EX 1040, 39 parts by mass of YH 1120, and 2 parts by mass of U-Cat 18X. Also, the entire test sample with the mixture liquid interposed between glass substrates was left in the oven at 80° C. for two hours, and was then left in the oven at 130° C. for five hours. Other than those described above, under conditions similar to those of Sample 1, the information recording medium of Sample 13 was fabricated.

[Sample 14]

The prepared A liquid and B liquid were mixed together at a ratio of 1:9, and this mixture liquid had the following composition: 6 parts by mass of EX 1020, 49 parts by mass of EX 1040, 45 parts by mass of YH 1120, and 2 parts by mass of U-Cat 18X. Other than those described above, under conditions similar to those of Sample 13, the information recording medium of Sample 14 was fabricated.

[Sample 15]

To the prepared B liquid, 2.0 phr of a special amine-based curing agent (product name: U-Cat 18X, manufactured by San-Apro Ltd.) was added as a curing accelerator, thereby obtaining a mixture liquid. Other than those described above, under conditions similar to those of Sample 13, the information recording medium of Sample 15 was fabricated.

<Measurement of Density and Glass Transition Temperature (Tg)>

A density of the cured material of each of Sample 1 to Sample 15 was measured by a dry-type density measurement apparatus (product name: ACUPIC 1330 manufactured by Shimadzu Corporation). Also, a glass transition temperature (Tg) was measured by a dynamic viscoelasticity measurement apparatus (DMA: Dynamic Mechanical Analysis) (product name: RSA-3, manufactured by TA Instruments). Specifically, the sample size was 5 mm in width ×20 mm in length, and a temperature at a maximum point of tan σ (loss elastic modulus/storage elastic modulus) obtained under a measurement condition at a frequency of 11 MHz was taken as a glass transition temperature.

<Write Recording Evaluations>

A fundamental wave of 800 nm (pulse width: 2.2 psec) of a Ti:S laser (manufactured by Coherent, Inc.) was converted to a second harmonic generation of 405 nm to generate pulse trains. A shutter of an electrooptic (EU) element was opened and closed to control irradiation of the pulse trains only for a predetermined time, and light passing through the EO element was focused onto the information recording medium by a microscopic objective lens (NA 0.85) (objective out: power of 170 W, repetition frequency: 76 MHz), thereby forming recording marks. Also, a photodiode was connected to an oscilloscope to monitor whether the shutter normally operated. Also, the movement of the information recording medium was strictly controlled by an XY stage.

Writing was performed with varied irradiation time, and a plurality of recording mark trains with different irradiation times were formed.

For reading, a 405-nm semiconductor laser was coaxially aligned, and returned light from any recording mark with respect to reconstructive light was detected by a CCD (Charge Coupled Device). Then, the shortest irradiation time when returned light was detected was taken as write time.

Table 1 depicts measurement results of density, glass transition temperature (Tg), and write time of Sample 1 to Sample 15.

TABLE 1

| | | | | | | | | WRITE |
|---|---|---|---|---|---|---|---|---|
| | | CURING | AMOUNT | CURING | | DENSITY | | TIME |
| SAMPLE | EPOXY RESIN | AGENT | (phr) | CONDITIONS | | (g/cm³) | Tg (° C.) | (μsec) |
| 1 | 4032D | DMP-30 | 0.4 | 80° C. | 24 h | 1.2668 | 106 | 0.7 |
| 2 | 4032D | DMP-30 | 0.5 | 80° C. | 12 h | 1.2669 | 108 | 0.5 |
| 3 | 4032D | DMP-30 | 1.0 | 80° C. | 12 h | 1.2676 | 116 | 0.4 |
| 4 | 4032D | DMP-30 | 2.0 | 80° C. | 12 h | 1.2656 | 124 | 0.3 |
| 5 | 4032D | DMP-30 | 4.0 | 80° C. | 12 h | 1.2539 | 133 | 0.45 |
| 6 | 4032D | DMP-30 | 6.0 | 80° C. | 12 h | 1.2526 | 143 | 1.1 |
| 7 | 4032D | U-Cat18X | 1.0 | 80° C. | 12 h | 1.2633 | 107 | 0.9 |
| 8 | 4032D | U-Cat18X | 1.5 | 80° C. | 12 h | 1.2492 | 115 | 0.7 |
| 9 | 4032D | U-Cat18X | 2.0 | 80° C. | 12 h | 1.2488 | 121 | 0.5 |
| 10 | 4032D | U-Cat18X | 3.0 | 80° C. | 12 h | 1.2446 | 125 | 0.3 |
| 11 | 4032D | U-Cat18X | 4.0 | 80° C. | 12 h | 1.2403 | 141 | 0.4 |
| 12 | 4032D | U-Cat18X | 6.0 | 80° C. | 12 h | 1.2378 | 147 | 1.0 |
| 13 | EX1020/1040 | U-Cat18X | 2.0 | 80° C. | 2 h | 1.1931 | 110 | 1.3 |
| | (CONTAINING | | | 130° C. | 5 h | | | |
| | CURING | | | | | | | |
| | AGENT YH | | | | | | | |
| | 1120) | | | | | | | |
| 14 | EX1020/1040 | U-Cat18X | 2.0 | 80° C. | 2 h | 1.2012 | 123 | 0.6 |
| | (CONTAINING | | | 130° C. | 5 h | | | |
| | CURING | | | | | | | |
| | AGENT YH | | | | | | | |
| | 1120) | | | | | | | |
| 15 | EX1040 | U-Cat18X | 2.0 | 80° C. | 2 h | 1.1993 | 126 | 0.9 |
| | (CONTAINING | | | 130° C. | 5 h | | | |
| | CURING | | | | | | | |
| | AGENT YH | | | | | | | |
| | 1120) | | | | | | | |

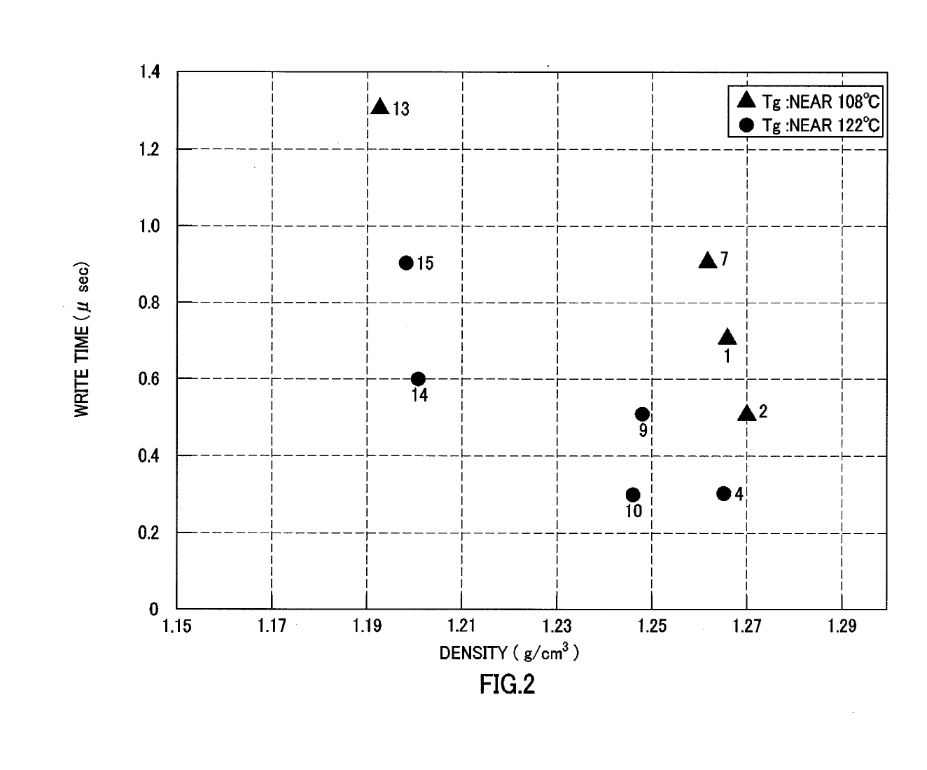

Also, FIG. 2 s a graph showing a relation between density and write time when Tg is fixed. As depicted in FIG. 2, it has been found that, in Samples 1, 2, 7, and 13 with Tg near 108° C. and Samples 4, 9, 10, 14, and 15 with Tg near 122° C., as the density is increased, the write time is decreased. Specifically, it has been found that with a density equal to or larger than 1.210 g/cm³, a write time equal to or smaller than 0.5 μsec can be achieved.

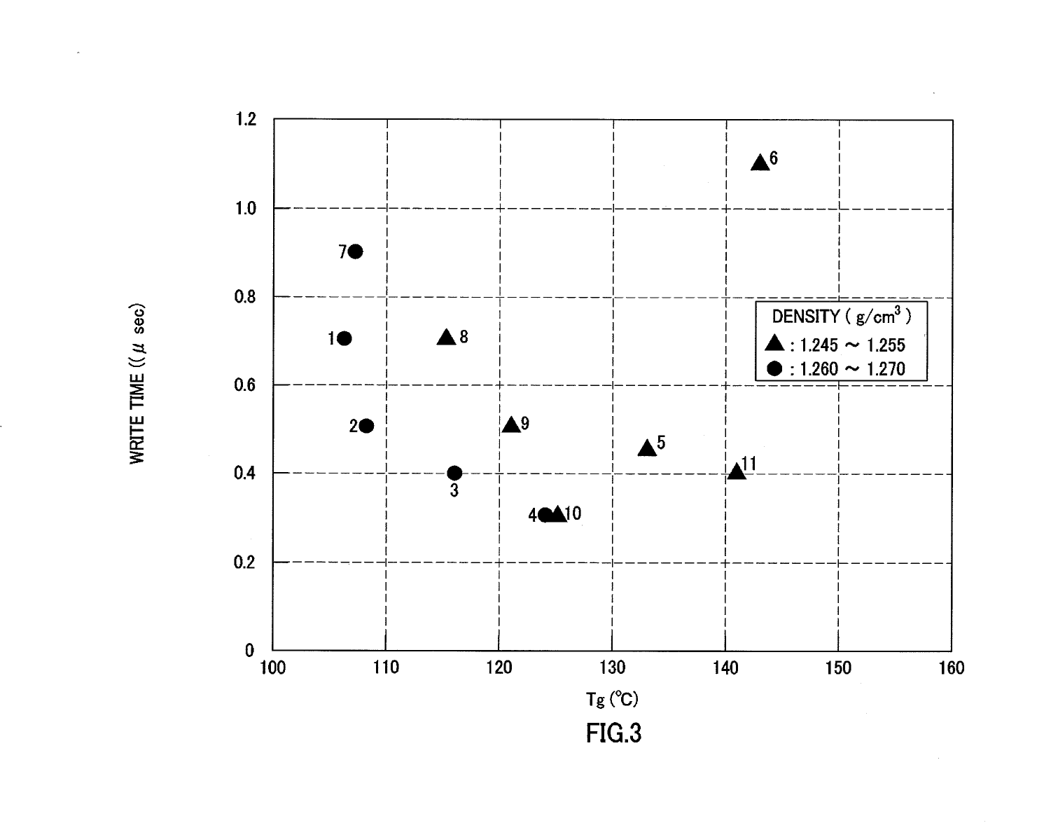

Furthermore, FIG. 3 is a graph showing a relation between density and write time when density is fixed. As depicted in FIG. 3, in Samples 1 to 4, and 7 with a density of 1.245 to 1.255 and Samples 5 to 9 and 11 with a density of 1.260 to 1.270, the write time was reduced at a glass transition temperature in a range of 110° C. to 140° C. The reason for this can be thought such that, with the glass transition temperature equal to or higher than 110° C., cavities formed by pulse laser light are kept and, with the glass transition temperature equal to or lower than 140° C., the amount of kinetic energy for forming cavities is saved.

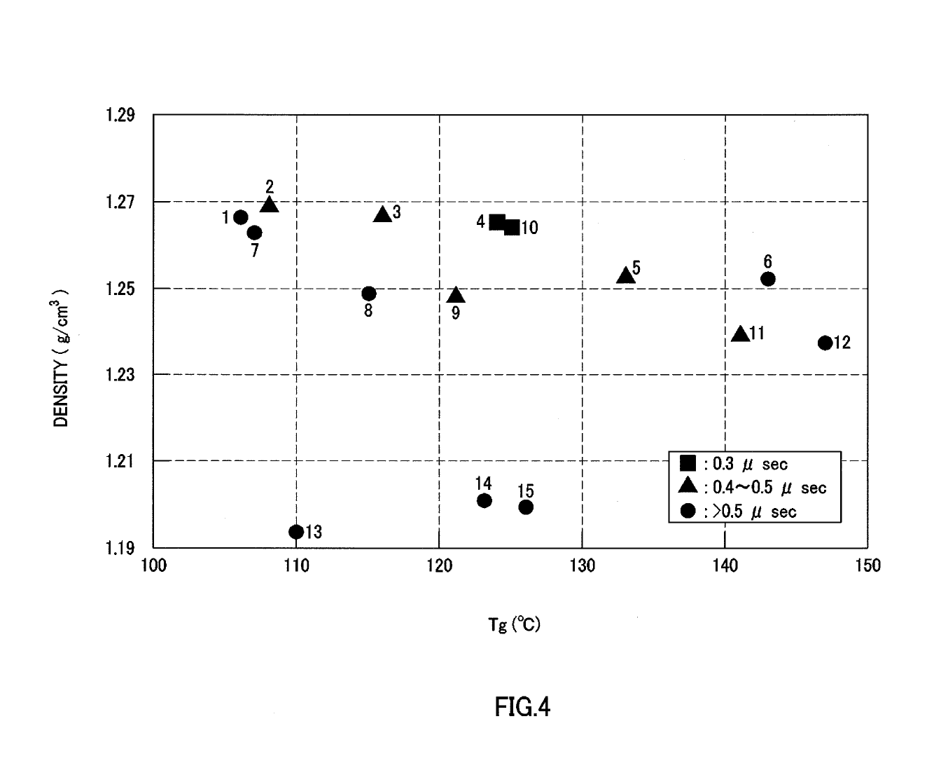

Still further, FIG. 4 is a graph showing a relation between glass transition temperature and density. As depicted in FIG. 4, if the recording layer has a density equal to or larger than 1.210 g/cm³ and a glass transition temperature of 110° C. to 140° C., a write time equal to or smaller than 0.7 μsec was achievable. Furthermore, if the recording layer has a density equal to or larger than 1.240 g/cm³ and a glass transition temperature of 120° C. to 130° C., a write time equal to or smaller than 0.5 μsec was achievable.

### REFERENCE SIGNS LIST

10 . . . information recording medium, 11 . . . recording layer, 12 . . . guide pattern, 20 . . . objective lens

1. An information recording medium comprising a recording layer in which an epoxy resin having two or more benzene rings in a molecule and a curing agent are polymerized, the recording layer having a density equal to or larger than 1.210 g/cm³, wherein a recording mark is to be formed or has been formed in the recording layer.

2. The information recording medium according to claim 1, wherein the recording layer has a glass transition temperature of 110° C. to 140° C.

3. The information recording medium according to claim 1, wherein the recording layer has a density equal to or larger than 1.240 g/cm³ and a glass transition temperature of 120° C. to 130° C.

4. The information recording medium according to claim 1, wherein
the epoxy resin has at least one of a naphthalene skeleton, a fluorene skeleton, an anthracene skeleton, a bisphenol A skeleton, and a biphenyl skeleton.

5. The information recording medium according to of claim 1, wherein
pulse laser light focused onto the recording layer has a peak power equal to or larger than 1 W and a pulse width equal to or smaller than 1 ns.

6. An information recording medium manufacturing method of polymerizing, between transparent substrates, an epoxy resin having two or more benzene rings in a molecule and a curing agent to form a recording layer having a density equal to or larger than 1.210 g/cm³.

7. An information recording material in which an epoxy resin having two or more benzene rings in a molecule and a curing agent are polymerized, the information recording material having a density equal to or larger than 1.210 g/cm³.

8. The information recording medium according to claim 2, wherein
the epoxy resin has at least one of a naphthalene skeleton, a fluorene skeleton, an anthracene skeleton, a bisphenol A skeleton, and a biphenyl skeleton.

9. The information recording medium according to claim 2, wherein
pulse laser light focused onto the recording layer has a peak power equal to or larger than 1 W and a pulse width equal to or smaller than 1 ns.

10. The information recording medium according to claim 3, wherein
the epoxy resin has at least one of a naphthalene skeleton, a fluorene skeleton, an anthracene skeleton, a bisphenol A skeleton, and a biphenyl skeleton.

11. The information recording medium according to claim 3, wherein
pulse laser light focused onto the recording layer has a peak power equal to or larger than 1 W and a pulse width equal to or smaller than 1 ns.

12. The information recording medium according to claim 4, wherein
pulse laser light focused onto the recording layer has a peak power equal to or larger than 1 W and a pulse width equal to or smaller than 1 ns.
